(19) United States
(12) Patent Application Publication
(10) Pub. No.: US 2009/0290676 A1
(43) Pub. Date: Nov. 26, 2009

(54) NUCLEAR-ENGINEERING PLANT AND METHOD OF OPERATING A NUCLEAR-ENGINEERING PLANT

(75) Inventor: Manfred Meintker, Möhrendorf (DE)

Correspondence Address: LERNER GREENBERG STEMER LLP, P O BOX 2480, HOLLYWOOD, FL, 33022-2480, US

(73) Assignee: AREVA NP GMBH, Erlangen (DE)

(21) Appl. No.: 12/471,706

(22) Filed: May 26, 2009

Related U.S. Application Data
(63) Continuation of application No. PCT/EP2007/009369, filed on Oct. 29, 2007.

(30) Foreign Application Priority Data
Nov. 24, 2006 (DE) 10 2006 055 966.5

(51) Int. Cl. G21C 15/02

(52) U.S. Cl. 376/367

(57) ABSTRACT

A nuclear-engineering installation has a pressurized-water reactor and a degasification system for reactor coolant. The degasification system has a degasification column which is coupled to the primary cooling circuit of the pressurized water reactor and further includes a coolant evaporator with a first heat exchanger and a stripping vapor condenser with a second heat exchanger, wherein a partial flow of the reactor coolant flows through the heat exchanger of the coolant evaporator on the secondary side, and wherein the heat exchanger of the stripping vapor condenser is connected, on the primary side, in a vapor and gas outlet line which is connected to the degasifier column. The degasification system is intended to be configured such that, with as simple a design as possible and taking into consideration relevant safety procedures, a particularly effective and at the same time energy-efficient separation of gasses, which are dissolved in the reactor coolant and cannot be condensed, is made possible, wherein the thermal load of the assigned nuclear intermediate cooling system is furthermore intended to be kept as low as possible. To this end it is provided that the heat exchanger of the coolant evaporator is switched in a heat-pump circuit on the primary side, which heat-pump circuit is coupled to the heat exchanger of the stripping vapor condenser with respect to the heat flux, which is established during plant operation, such that the heat liberated in the strip steam condensation is transferred at least partially to the reactor coolant, which flows through the coolant evaporator, and thus causes its evaporation.

### CROSS-REFERENCE TO RELATED APPLICATION

This is a continuing application, under 35 U.S.C. § 120, of copending international application No. PCT/EP2007/009369, filed Oct. 29, 2007, which designated the United States; this application also claims the priority, under 35 U.S.C. § 119, of German patent application No. DE 10 2006 055 966.5, filed Nov. 24, 2006; the prior applications are herewith incorporated by reference in their entirety.

### BACKGROUND OF THE INVENTION

### Field of the Invention

The invention relates to a degasification system for reactor coolant. The degasification system has a degasifier column through which the reactor coolant can flow. The degasification system comprises a coolant evaporator with a first heat exchanger and a stripping vapor condenser with a second heat exchanger, wherein a partial stream of the reactor coolant flows through the heat exchanger of the coolant evaporator on the secondary side, and wherein the heat exchanger of the stripping vapor condenser is connected, on the primary side, into a vapor and gas exit line which is connected to the degasifier column. The invention further relates to a nuclear-engineering plant having a degasification system for reactor coolants and to a method of operating such a nuclear-engineering plant.

Depending on the operation, dissolved, non-condensable gas, such as hydrogen, oxygen, nitrogen and various radioactive noble gases, such as ⁸⁵Kr, ¹³³Xe, is present in the reactor coolant of pressurized-water reactors. Depending on the state of operation of the reactor plant, the presence of the gases in the coolant is either necessary and intended or of no major importance, or harmful and undesired and should therefore be avoided.

The following examples are meant to explain this further:

During power operation of the reactor, dissolved hydrogen (H₂) is necessary in a concentration of, for example, 2 ppm to 4 ppm in order to limit the concentration of oxygen, which is harmful in that state of operation (since it causes corrosion), to a minimum. Before the reactor is shut down for inspection purposes, the hydrogen needs to be removed, however, in order to firstly enable the chemical conditioning of the coolant necessary for that state and secondly to avoid the risks of explosion when the reactor cooling circuit is opened.

During the inspection of the reactor, oxygen dissolves in the reactor coolant nearly up to the saturation limit (ca. 8 ppm), which is of no consequence in the state since oxygen is neither useful nor harmful. However, once the reactor is started up again after the inspection, oxygen is permissible only in very small concentration (for example 5 ppb) since it could cause impermissible corrosion of the structural materials under the operating conditions of the reactor cooling circuit.

Many experts in the field regard the presence of nitrogen, which is introduced into the reactor cooling system for example from the gas cushion in various containers and apparatuses in which the reactor coolant is handled, as irrelevant. Others, in turn, consider increased nitrogen concentrations to be undesired since, firstly, they do not exclude interaction with the cladding tube material of the fuel assemblies and, secondly, a low, negative influence on the ion exchangers in the coolant cleaning system may also exist.

The radioactive noble gases which originate from nuclear fission in the reactor and are dissolved in the coolant are of no importance during the power operation of the reactor plant since they are chemically inert and the radioactive radiation which they emit is sufficiently absorbed by the shielding which is already present. During maintenance work or repairs in the reactor plant, however, they have an obstructive effect due to the radiation they emit. In particular when the reactor lid is opened, these noble gasses can be released into the surrounding air, which makes it necessary to clear the reactor containment in order to protect the staff. It is therefore desirable to remove the radioactive noble gases from the coolant when the reactor is shut down for inspection purposes.

For the abovementioned reasons, it is therefore necessary to control the content of dissolved, non-condensable gases in the reactor coolant. To this end, nuclear-engineering plants with pressurized-water reactors have various devices which can be used, on the one hand, to introduce various gases (in particular hydrogen) into the coolant or to remove dissolved gas from the coolant on the other hand. The devices for adding gas do not form the object of this invention and will therefore not be explained further herein. Rather, the object of the invention is a particularly energy-efficient concept for removing dissolved gas from the coolant.

Statements concerning the principles of process engineering, radiation protection measures, operating, servicing and monitoring of primary coolant degasification systems are included, for example, in the German Industry Standard DIN 25476.

By way of example, the volume control tank present in the volume control system is used to remove dissolved gas in many pressurized-water reactor plants. The reactor coolant removed from the reactor cooling circuit is sprayed above the surface of the water in the volume control tank and thus enters into a virtual equilibrium state with the gas atmosphere present in the container above the surface of the liquid with respect to the concentration of the gases dissolved in the coolant. If the gas atmosphere is originally free of oxygen, the oxygen concentration in the reactor coolant which is collected at the bottom of the volume control tank is reduced during the spraying process. It is thus possible to remove oxygen from the reactor coolant, for example, if a pure hydrogen atmosphere is provided when the reactor is started up. If a pure nitrogen atmosphere is present in the volume control tank, hydrogen can be removed from the coolant in the manner described. This variant is thus used when the reactor is shut down for inspection purposes. The coolant thus treated is subsequently fed back into the reactor cooling circuit using the feed pumps of the volume control system, with the result that there, as desired, the concentration of the relevant type of dissolved gas is reduced. However, this process only has a comparatively low efficiency and often leads to delays in the operation of the power plant since the specified values of the maximum gas concentration are not achieved in time. This is because what is desired is usually time durations of less than one day for the necessary changes in the gas content which can hardly be observed with the method described.

In another type of pressurized-water reactor plants, a degasifier column is used for the removal of dissolved gas from the reactor coolant. The degasifier column is provided specifically for this purpose and has a decont factor for non-condensable gases of >100. The decont factor describes the ratio between the concentrations at the entrance and at the exit of the apparatus. Here, the coolant to be degassed is fed into the head of a degasifier column, typically a bubble-cap column. In this column, it trickles downward from above due to gravity, and at the same time vapor rises up from the column sump. This vapor is produced by evaporation of some—typically 5% of the nominal throughput through the column—of the cooling water which collects in the column sump in an evaporator which is connected at the bottom of the column. The apparatus acts to degas the cooling water in the column sump and the vapor produced in the evaporator is thus suitable, as the so-called stripping vapor, for having, or increasing, the degassing effect on the cooling water which trickles down. This is because each time the cooling water which trickles down passes a bubble-cap tray, it comes into intensive contact with the rising stripping vapor due to the action of the bubble-caps, as a result of which the dissolved gas separates from the water and moves upward toward the head of the column together with the vapor. That is to say the stripping vapor and the non-condensable gasses move in the degasifier column counter to the flow of the (liquid) reactor cooling water.

In order to achieve as optimum an action of the degasification process as possible, it is advantageous if the medium to be degassed already has a temperature when it is fed into the column head which corresponds to the boiling temperature according to the pressure selected for the separation process in the column. The process is completed by condensing the vapor portion in the vapor-gas mixture which exits at the column head and by recycling the condensate into the column head, while the remaining non-condensable gas is taken from the condenser, is subsequently dried by further cooling and is forwarded to a suitable gaseous-waste system for further treatment. As in the systems (described further above) with gas removal in the volume control tank, after the degasification process, the feed pumps of the volume control system are used to feed back the degassed coolant into the reactor cooling circuit, where the coolant effects the desired reduction of the dissolved, non-condensable gases. The effect on the coolant in the reactor cooling circuit is usually considered to be particularly beneficial if, on the one hand, a decont factor of >100 is achieved and, on the other hand, the proportion of the coolant stock in the reactor cooling circuit, which is degassed thus per hour, is approximately 20% of the total amount.

As can be seen from the above description, the use of energy for evaporating coolant at the sump of the column, i.e. for the production of stripping vapor, on the one hand, and the dissipation of a corresponding amount of energy from the condenser at the column head on the other hand are necessary for the degasification process. If the coolant removed from the reactor cooling circuit is not supplied to the degasification column at the boiling temperature according to the column pressure prevailing inside it, energy for heating it to the temperature and a corresponding cooling-down at the end of the process are also necessary. The stated requirement of energy input and of cooling results, depending on the size of the reactor cooling system, in significant thermal powers of the stated evaporators and condensers. A first embodiment of the degasification system described was installed, for example, in the pressurized-water reactor plants Neckarwestheim I (Germany) and Gösgen (Switzerland). It operates approximately at atmospheric pressure (1 bar absolute), and so the evaporation temperature for the coolant is about 100° C. In order to heat the cooling water from the feed-in temperature from the volume control system of about 50° C. to the necessary entry temperature into the column head of 100° C., a significant amount of thermal power needs to be applied additionally to the evaporation power. For subsequent reactor plants with even larger reactor cooling circuits, an evacuation pump was therefore connected to the column head of the degasification system, downstream, in the direction of flow, of the stated condenser and gas cooler, which evacuation pump is used to lower the pressure in the column to such an extent, specifically to about 0.125 bar absolute, that the coolant which is fed in at about 50° C. is already in the boiling state without further pre-heating. This achieves a significant saving in terms of energy compared to the above-described, original embodiment of the degasification system.

Nevertheless, even when a vacuum degasification system is used, the input of energy for the operation remains considerable. By way of example, in a pressurized-water reactor plant designed for a total thermal power of 4000 MW to 4500 MW, the thermal power both of the evaporator and of the condenser is approximately 2.3 MW to 2.5 MW. The power is input in the power plants described so far from the auxiliary vapor network available there from the conventional part of the plant; dissipation of the power from the condenser and the gas cooler is effected by way of the nuclear intermediate cooling circuit. In more recent nuclear power plants of the reactor type EPR (European Pressurized Water Reactor) which are currently being built, there is no longer any auxiliary vapor supply system inside the nuclear part of the plant. Here, the power requirement for the evaporator of the degasification system is covered by an electric resistance heater. The thermal power is, as before, dissipated from the condenser with the aid of the nuclear intermediate cooling circuit.

All of the variants of the degasification system realized or designed until now thus require a substantial plant-technical outlay for the supply and removal of the heat applied during the degasification process. Further outlay is required in order to dissipate the heat losses of the plant components used from the ambient air by means of the nuclear ventilation system. In the electrically heated variant of the degasification system, this also applies particularly for the lost heat of the transformer arranged in the vicinity of the degasification system, which transformer is required to operate the heating elements for the voltage supply. In nuclear power plants, at whose site the secondary cooling water, to which the nuclear intermediate cooling circuit dissipates the absorbed heat, has a comparatively high temperature of for example 31° C. or even more, another disadvantage of the conventional degasification systems can be seen, which is associated with the high thermal power which is to be removed from the condenser. This is because the chain of the nuclear intermediate cooling system, which supplies the condenser of the degasification system, is also required, in the case of a plant shut-down, to remove the residual heat of the shut down reactor. In other words: the dissipation of heat from the reactor cooling circuit via the residual-heat exchanger and the operation of the degasifier system with thermal dissipation from the condenser need to be managed at the same time parallel with the same chain of the intermediate cooling system. In the case of the stated high secondary cooling water temperatures, this results in the design and the dimensioning, which have so far been typical and are matched to low secondary cooling water temperatures, of the intermediate cooling circuit no longer being sufficient. The temperature of the reactor cooling system can in this case no longer be lowered to the comparatively low values needed for the inspection within the required time period, or the size of the components, pipelines and fittings of the intermediate cooling system needs to be increased excessively.

### SUMMARY OF THE INVENTION

It is accordingly an object of the invention to provide a degasification system of the type mentioned at the outset, which overcomes the above-mentioned disadvantages of the heretofore-known devices and methods of this general type and which permits a particularly effective and at the same time energy-efficient separation off of non-condensable gases dissolved in the reactor coolant while maintaining as simple a design as possible and while observing relevant safety regulations, wherein furthermore the thermal load of the assigned nuclear intermediate cooling system needs to be kept as low as possible. A nuclear-engineering plant and a corresponding method for operating a nuclear-engineering plant will furthermore be specified.

With the foregoing and other objects in view there is provided, in accordance with the invention, a nuclear-engineering plant, comprising a pressurized-water reactor and a degasification system for the reactor coolant. The system includes:

a degasifier column through which the reactor coolant can flow;

a coolant evaporator with a first heat exchanger connected to said degasifier column, said first heat exchanger having a primary side and a secondary side;

a stripping vapor condenser with a second heat exchanger;

wherein a partial stream of the reactor coolant flows through said secondary side of said first heat exchanger of said coolant evaporator;

wherein said second heat exchanger of said stripping vapor condenser has a primary side connected into a vapor and gas exit line connected to said degasifier column;

a heat pump circuit connected to said primary side of said first heat exchanger of said coolant evaporator and coupled, in relation to a thermal flow that is established during plant operation, to said second heat exchanger of said stripping vapor condenser, for transferring at least some heat released in a stripping vapor condensation to the reactor coolant flowing through said coolant evaporator and to thereby lead to the evaporation thereof.

In other words, with respect to the degasification system, the objects of the invention are achieved in that the heat exchanger of the coolant evaporator is connected on the primary side into a heat pump circuit which is coupled, in relation to the thermal flow which is established during plant operation, to the heat exchanger of the stripping vapor condenser such that at least some of the heat released in the stripping vapor condensation is transferred to the reactor coolant, which flows through the coolant evaporator, and thus leads to the evaporation thereof.

The invention is based on the consideration that in order to achieve a particularly energy-efficient operation of a degasification system in a nuclear-engineering plant with a pressurized-water reactor, the evaporation heat needed to produce stripping vapor should be recovered at least in part at the condenser of the degasification system and recycled to the evaporator. In the process, the amount of heat removed at the condenser should be raised to a temperature level which is far enough above the evaporation temperature in the evaporator or in the column sump of the degasifier column for an effective thermal transfer with economically sensible heat exchanger surfaces to be able to take place there on account of the prevailing temperature gradient. The underlying process should for operational safety reasons be designed such that the reactor coolant does not mix with the other substances which play a part in the method or can be found in circulation, such as the nuclear intermediate cooling water. Furthermore, the heat recycling process should be designed such that the radioactively loaded reactor coolant cannot be released. The formation of potentially explosive gas mixtures, as is possible for example in the so-called vapor compression of the reactor coolant as a result of air entering at the compressor, should be prevented right from the outset.

These design goals, which are in part contradictory, are realized according to the concept introduced here by transferring the heat of condensation released at the condenser during the stripping vapor condensation to a heat pump circuit which is coupled on the thermal-flow side but is separate from the flow medium and increasing it there with input of mechanical power at the heat pump to the temperature level which is required to evaporate the reactor coolant. Due to the media-side separation of primary cooling circuit and heat pump circuit, realized by way of appropriate heat exchangers, any prohibited influence on the chemical quality of the reactor coolant is avoided. Only the non-radioactive cooling medium in the heat pump circuit, rather than the reactor coolant itself, is compressed by way of the compressor heat pump. In a system which is based on this concept, it is possible to lower the power which needs to be supplied from the outside for the separation process in the degasification system by about 80% with respect to a vacuum degasifier which is heated using auxiliary vapor or using electric resistance heaters. This applies accordingly to the power which is to be removed with the cooling water from the condenser into the surrounding area. By way of example, in a 1400 MW nuclear power plant, the thermal power which must be transferred by the nuclear intermediate cooling circuit from the vacuum degasifier system to the secondary cooling water can be lowered from about 2.3 MW to about 0.4 MW. That means that the load on the intermediate cooling system is correspondingly decreased.

In a first advantageous variant, a secondary-side outlet of the heat exchanger, which is associated with the stripping vapor condenser, is connected via a connection line to a primary-side inlet of a third heat exchanger which is connected on the secondary side into the heat pump circuit. Here, the connection line advantageously forms a subsection of a nuclear intermediate cooling circuit of the nuclear-engineering plant. The heat which is present at the stripping vapor condenser is thus first transferred to the intermediate cooling water which is carried in the nuclear intermediate cooling circuit and then, from there, to the cooling medium carried in the heat pump circuit by way of the third heat exchanger. The compression heat pump in the heat pump circuit is used to compress the cooling medium, wherein its temperature rises such that the heat recycled from the condenser can be used for the evaporation of the reactor coolant in the coolant evaporator of the degasification system. Depending on the thermal transfer powers of the heat exchangers installed, for example 80% of the evaporator power originates from the recycled heat from the condenser and, accordingly, 20% from the drive power of the compressor. Since the heat balance in the system needs to be balanced overall, a corresponding proportion of the heat given off by the condenser into the nuclear intermediate cooling water remains there and is transferred, via further heat exchangers, into the secondary cooling water.

In a second advantageous variant, the heat exchanger of the stripping vapor condenser is connected on the secondary side directly into the heat pump circuit, with the result that the heat from the stripping vapor condenser is absorbed directly by the cooling medium of the heat pump circuit and is subsequently transferred in a so-called cross flow circuit to the coolant evaporator of the degasification system. In this variant, in order to balance the heat balance, a thermal power which corresponds approximately to the operating power of the compressor (for example about 20% of the evaporator power) needs to be transferred to the nuclear intermediate cooling circuit. To this end, the heat pump circuit has advantageously a controllable bypass line to the heat exchanger of the coolant evaporator, into which, on the primary side, an excess heat exchanger, which is connected on the secondary side into the nuclear intermediate cooling circuit, of an excess condenser is connected.

In both variants, the heat exchanger of the coolant evaporator is advantageously connected on the secondary side into a recirculation subcircuit line which is connected by both ends to the degasifier column and through which a partial flow of the degassed reactor coolant flows. The recirculation of the reactor coolant between column sump and coolant evaporator preferably takes place here in natural circulation which is driven by the vapor proportion produced in the evaporator.

In order to cool the non-condensable gases which emerge together with the stripping vapor via the gas and vapor exit line at the column head, a gas cooler is expediently provided, which gas cooler is connected on the coolant side parallel to the stripping vapor condenser and downstream of it on the vapor and gas side. That is to say that in the first of the two above-described variants, the gas cooler is cooled by way of the nuclear intermediate cooling water and in the second variant by way of the cooling medium which circulates in the heat pump circuit and is comparatively cool after the pressure in it is relieved by way of an expansion valve.

The degasification system is preferably designed as a so-called vacuum degasification system. A vacuum pump is here connected into the gas and vapor exit line which is connected to the column head, with the suction power of the vacuum pump being designed for an operating pressure, in the interior of the degasifier column, of less than 0.5 bar, preferably less than 0.2 bar. As a result of the reduced interior pressure in the degasifier column, the boiling temperature of the reactor coolant therein is lowered to such a degree, for example to about 50° C., that the gas-containing reactor coolant, which is fed in from the reactor cooling system via the volume control system, can be fed into the column head already at its boiling temperature without the need to additionally preheat.

With the above and other objects in view there is also provided, in accordance with the invention, a method of operating a nuclear-engineering plant having a pressurized-water reactor and a degasification system with a coolant evaporator and a stripping vapor condenser for reactor coolant, the method which comprises:

condensing stripping vapor in the stripping water condenser and releasing heat of condensation;

introducing the heat of condensation from the stripping vapor condenser into a heat pump circuit; and

transferring at least some of the heat of condensation to a subflow of the reactor coolant flowing through the coolant evaporator to thereby evaporate the same.

In other words, with respect to the method, the objects of the invention are achieved by introducing the heat of condensation, which is released during the condensation of stripping vapor in the stripping vapor condenser, into a heat pump circuit and subsequently transferring at least some of it to a subflow of the reactor coolant which flows through the coolant evaporator, as a result of which it is evaporated. In a first advantageous variant, the heat of condensation which is released in the stripping vapor condenser is here first transferred to a flow medium which is carried in a nuclear intermediate cooling circuit and, from there, subsequently to a cooling medium which is carried in the heat pump circuit by means of a heat exchanger. Alternatively, in a second advantageous variant, the heat of condensation which is released in the stripping vapor condenser is transferred directly to a cooling medium carried in the heat pump circuit.

In a particularly preferred embodiment of the method, the operating pressure inside the degasifier column is adjusted such that the boiling temperature of the reactor coolant is there within the range of 40° C. to 60° C., in particular approximately 50° C. Here, the temperature of the cooling medium in the heat pump circuit before entry into the heat exchanger of the coolant evaporator is advantageously increased by a compression pump to 60° C. to 80° C., in particular to about 70° C., which, at the pressure conditions stated, is sufficient for the reactor coolant to evaporate.

The preferred cooling medium used in the heat pump circuit is a fluorinated hydrocarbon, in particular the 1,1,1,2-tetrafluoroethane (also known under the name R134a) which is particularly well matched to the temperature conditions mentioned above and is moreover distinguished by its chemical stability, low toxicity and the fact that it is free of chlorine and is not flammable. Suitable heat pumps are conventional compressor heat pump aggregates, as are used for example in the relevant nuclear power plants with pressurized-water reactors also for producing cold water in the cold water systems, in particular also with the power levels now required in the heat pump circuit.

In addition to the advantages already mentioned, the apparatus which is now provided and the associated method for coolant degasification with heat recovery offer in particular the following advantages compared to the hitherto known degasification systems with auxiliary vapor heaters or with electric heaters.

The necessary supply and removal of thermal power into the balance range of the degasification system is reduced, in the case of a 1400 MW nuclear power plant, from about 2.3 MW to about 0.4 MW.

The lines and fixtures, which have a large volume, for auxiliary vapor and auxiliary vapor condensate are no longer necessary, and neither are the auxiliary vapor condensate cooler and corresponding tanks and pumps.

The elaborate supply of electric power for the production of heat while using an in-situ transformer is no longer necessary.

The supply of the necessary electric power for the compressor (in the example about 400 kW) can easily be effected at a medium voltage level.

The nuclear intermediate cooling system now only needs to remove a comparatively small amount of power (in the example about 400 kW) corresponding to the compressor power.

The electric supply needed by the nuclear power plant itself is thus significantly reduced.

The cooling water lines and fixtures can be designed to have a significantly smaller nominal width, in particular in the case of the second variant with direct heat transfer from the stripping vapor condenser to the heat pump circuit.

The maximum capacity for the relevant chain of the nuclear intermediate cooling system when the plant is shut down is correspondingly reduced.

The heat losses from the degasifier system into the ambient air are reduced significantly since no plant components with high temperatures are any longer part of the process. The lost heat of the compressor motor is removed directly from the cooling medium in the heat pump circuit and recovered.

The heat which needs to be removed in an elaborate fashion from the nuclear ventilation system with the aid of cooling machines is correspondingly reduced.

The components to be used for the heat pump circuit are largely known from the cold-water systems of the nuclear power plants and can be considered to be tried and tested in terms of operation, as opposed to the electric resistance heaters.

In particular, the concept which is now provided can be used to design a nuclear-engineering plant with a pressurized-water reactor even at sites with unfavorable cooling water conditions, that is to say comparatively high cooling water temperatures, with a balanced design of the auxiliary systems which are provided for coolant degasification.

Other features which are considered as characteristic for the invention are set forth in the appended claims.

Although the invention is illustrated and described herein as embodied in a nuclear-engineering plant and method of operating a nuclear-engineering plant, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings, in which identical and functionally corresponding components have been identified with the same reference signs throughout.

### BRIEF DESCRIPTION OF THE SEVERAL VIEWS OF THE DRAWING

FIG. 1 is a simplified circuit diagram of a degasification system with heat recovery according to a first exemplary embodiment of the invention; and

FIG. 2 is a simplified circuit diagram of a degasification system with heat recovery according to a second exemplary embodiment of the invention.

### DETAILED DESCRIPTION OF THE INVENTION

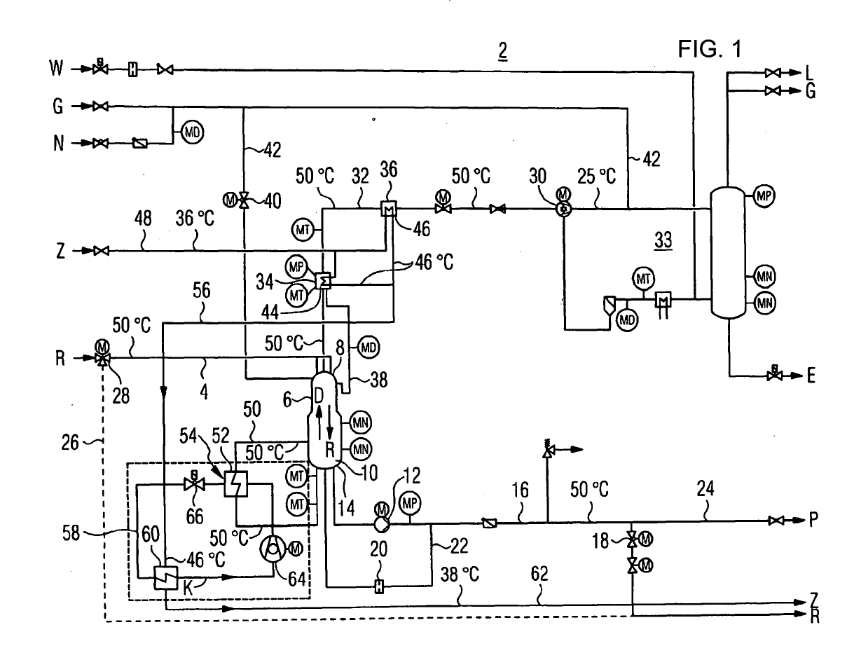

Referring now to the figures of the drawing in detail and first, particularly, to FIG. 1 which illustrates the degasification system 2 for reactor coolant R and a number of peripheral components, the system 2 comprises a degasifier column 6 to which gas-containing reactor coolant R is fed from the primary circuit of a pressurized-water reactor via a coolant inlet line 4. The gas-containing reactor coolant R enters during operation of the system 2 via the coolant inlet line 4 which is connected to the column head 8 into the degasifier column 6 at an inlet temperature of about 50° C., which corresponds to an operating pressure in the degasifier column 6 of about 0.125 bar approaching the boiling temperature, subsequently trickles down via a plurality of bubble-cap trays (not illustrated further here) and is finally collected in the column sump 10 of the degasifier column 6. While the reactor coolant R trickles down, it comes into intensive contact with stripping vapor D which is introduced into the degasifier column 6 just above the column sump 10 and flows through the column counter to the flow of the coolant. In the process, non-condensable gases, such as hydrogen, oxygen, nitrogen or various noble gases, which are dissolved in the reactor coolant R, are entrained by the stripping vapor D and transported upward toward the column head 8, wherein a decont factor of >100 is achieved.

The largest part of the degassed reactor coolant R which is collected in the column sump 10 is continuously extracted with the aid of a controllable degasifier extraction pump 12 via a coolant exit line 16 which is connected to the degasifier column 6 in the region of the column sump 14 and recycled via controllable outlet valves 18 into the reactor cooling system. Parallel to the degasifier extraction pump 12, a throttle valve 20 is connected into a pump bypass line 22 with the result that even if the degasifier extraction pump 12 is shut down or has failed a specific minimum amount of reactor coolant R per unit time can flow out of the degasifier column 6. If required, samples of the degassed reactor coolant R can be removed via a sampling line 24 which branches off from the coolant exit line 16. A degasifier bypass line 26 is also provided, so that the reactor coolant R can circumvent completely or in part the degasifier column 6 depending on requirements and application and depending on the operational state corresponding to the position of the controllable distributor valve 28, that is to say circulates without degasification.

The stripping vapor D which rises up in the degasifier column 6 and also contains proportions of the non-condensable gases which are removed from the reactor coolant R is extracted by suction with the aid of a degasifier vacuum pump 30 via a gas and vapor exit line 32 which is connected to the column head 8. The suction power of the degasifier vacuum pump 30 is such that during operation of the system 2 a reduced internal pressure in the degasifier column 6 of about 0.125 bar can be continuously maintained. The degasifier vacuum pump 30 which in the exemplary embodiment is in the form of a water ring compressor is a constituent part of a degasifier vacuum pump system 33 which is connected via a gaseous-waste line G to a gaseous-waste system (not shown here), which degasifier vacuum pump system 33 has a number of further components which act as auxiliary aggregates for the ring piston compressor (ring liquid tank, ring liquid cooler, ring liquid sieve) but for which details of the mode of operation are of no interest here.

Furthermore, a gas feed line 42 which is provided with a control valve 40 is connected to the column head 8 of the degasifier column 6, and the other end of the gas feed line 42 issues on the pressure side of the degasifier vacuum pump 30 into the gas and vapor exit line 32. The gas feed line 42 is used for controlling the pressure for the process in the degasifier column 6: with the aid of the control valve 40, exactly the right amount of gas is introduced via the gas feed line 42 from the gaseous waste system of the power plant into the column head 8 for the desired operating pressure of preferably 0.125 bar absolute to be established therein according to the characteristic curve of the degasifier vacuum pump 30. The introduced gas then also serves at the same time as a flushing/carrier gas and as “dilution” means for that gas, in particular hydrogen, that was removed in the column 6 from the reactor coolant R.

On the suction side of the degasifier vacuum pump 30, a stripping vapor condenser 34 for condensing the stripping vapor D and a downstream gas cooler 36 for cooling the gas components which still remain in the gas and vapor exit line 32 after the stripping vapor condensation are connected into the gas and vapor exit line 32. The condensate which forms in the stripping vapor condenser 34 is fed again, via a condensate line 38, to the column head 8 of the degasifier column 6 in order to trickle down together with the reactor coolant R which is supplied via the coolant entry line 16 and to undergo degasification in the process.

After it has passed the gas cooler 36, the non-condensable gas which flows out of the degasifier column 6 has a temperature of slightly less than 50° C. which is below the boiling temperature of the reactor coolant R, as a result of which the humidity content of the gas flowing in the direction of the degasifier vacuum pump 30 and the discharge of water vapor are effectively limited. During passage through the degasification vacuum pump 30, the gas temperature decreases further, to about 25° C. If appropriate, a second condensation step takes place in the gas cooler 36, during which the remaining proportion of the vapor D condenses with a slight undercooling and is subsequently fed as a liquid condensate into the column head 8 of the degasifier column 6, e.g. by way of gravity in counterflow to the vapor/gas mixture through the line 32 and through the stripping vapor condenser 34, or via a separate condensate line (not shown here) from the gas cooler 36.

On the coolant side, the heat exchanger 44 of the stripping vapor condenser 34 and the heat exchanger 46 of the gas cooler 36 are connected in parallel. The so-called intermediate cooling water Z is supplied to both from the nuclear intermediate cooling system of the reactor plant via a coolant line 48, wherein the entry temperature of the intermediate cooling water Z in the exemplary embodiment is about 36° C. Due to the heat transferred by the stripping vapor D or the non-condensable gases, the temperature of the intermediate cooling water Z rises on the exit side of the respective heat exchanger 44, 46 to about 46° C.

At the bottom 14 of the degasifier column 6, a first end of a recirculation line 50 is connected, through which a partial amount of the degassed reactor coolant R which is collected in the column sump 10 flows. The branched off subflow passes through the heated heat exchanger 52 of a coolant evaporator 54 and is evaporated in the process. The coolant vapor thus produced is guided into the degasifier column 6 again just above the filling height of the liquid reactor coolant R via the second end of the recirculation line 50, in which degasifier column 6 it acts as the stripping vapor D.

The degasification system 2 is designed specifically for particularly energy-efficient operation while at the same time keeping the load on the nuclear intermediate cooling system low. To this end, recovery of the heat of condensation which is released at the stripping vapor condenser 34 and the process of making it useful again for coolant evaporation, that is to say for stripping vapor production, are provided. The intermediate cooling water Z, which leaves the stripping vapor condenser 34 and the gas cooler 36 and has been heated therein to about 46° C. is, to this end, fed via the connection line 56 to a heat exchanger 60, which is connected on the secondary side into a heat pump circuit 58, and there releases the largest amount of the heat, which was previously taken up in the stripping vapor condenser 34 and in the gas cooler 36, to a cooling medium K which is carried in the heat pump circuit 58, such as the cooling medium R134a, which is thus evaporated. The intermediate cooling water Z which flows out of the heat exchanger 60 is subsequently recirculated to the nuclear intermediate cooling system via a line 62 at a temperature of now only about 38° C. The cooling medium K which evaporated in the heat exchanger 60, on the other hand, is compressed by the heat pump compressor 64 and delivered to the heat exchanger 52 of the coolant evaporator 54. As a result of the compression, the temperature of the cooling medium K rises to about 70° C., which is sufficient to bring about in the heat exchanger 52 the evaporation of the reactor coolant R which is carried in the recirculation line 50 and is still liquid in the beginning, since its boiling temperature—due to the lowered internal pressure in the degasifier column 6 and in the recirculation line 50 connected thereto—is only about 50° C. As already illustrated above, this is also approximately the same temperature as that of the reactor coolant R as it flows into the recirculation line 50. The cooling medium K is liquefied in the heat exchanger 52 by way of condensation. This means that the heat exchanger 52 is a condenser on its primary side with respect to the cooling medium K, and is an evaporator (coolant evaporator) on its secondary side with respect to the reactor coolant R. The cooling medium K which is liquid after its heat release in the heat exchanger 52 of the coolant evaporator 54 is expanded as it flows through the expansion valve 66 and cooled further, with the result that the above-described circuit can begin anew thereafter.

In order to start up the vacuum degasifier system 2, first the cooling water throughput through the stripping vapor condenser 34 and the gas cooler 36 is established by opening the corresponding fixtures. At the same time this causes flow of nuclear intermediate cooling water Z via the connection line 56 also through the heat exchanger 60 in the heat pump circuit 58, as a result of which the heat source in the heat pump circuit 58 is available. In the next step, the degasifier vacuum pump 30, which is typically designed as a water ring compressor, and the necessary feed and disposal systems (ring liquid inflow and outflow, cold water supply, flushing gas throughput from the gaseous waste system) are switched on. In the switched-on state, the degasifier vacuum pump 30 together with the associated closed control circuit which acts on the control valve 40 in the gas feed line 42 automatically maintains the necessary pressure of, for example, 0.125 bar in the degasifier column 6. The internal states inside the vacuum pump system, such as the filling level in the ring liquid tank, are also automatically kept at the necessary level.

Next, the filling level control means for the column sump 10 and the coolant evaporator 54 of the vacuum degasifier system 2 are started up. The control means switches on the degasifier extraction pump 12, opens the shutoff valve 18 in the outflow of the degasifier system 2 and adjusts the control valve which is likewise situated there with the aid of a controller such that the pipe bundle in the coolant evaporator 54 of the degasifier system 2 is continuously flooded. By opening the inlet valve of the volume control system, gas-containing reactor coolant R is now introduced into the column head 8 of the degasifier column 6, and at the same time the compressor 64 of the heat pump system is switched on. By compressing the cooling medium vapor with the compressor 64 of the heat pump circuit 58 to a pressure of, for example, 25 bar, its temperature is increased to such an extent that in the coolant evaporator 54 a large part of its heat is transferred to the reactor coolant R which is located on the other side of the heat exchanger 52, as a result of which the reactor coolant R is evaporated and can be used as the stripping vapor D in the degasifier column 6. Recirculation of the reactor coolant R between the column sump 10 and the coolant evaporator 54 preferably takes place in natural circulation driven by the vapor fraction produced in the coolant evaporator 54.

On the heat-pump side of the coolant evaporator 54, the cooling medium K which is still under high pressure, still condenses. Then it flows to the expansion valve 66, where it is expanded to a comparatively low pressure and, in the process, cools to such a degree that it can absorb in the heat exchanger 60 of the heat pump circuit 58 heat from the nuclear intermediate cooling water Z which flows on the other side. During this absorption of heat, the cooling medium K evaporates and can then be sucked in again by the compressor 64. The cooling medium circuit of the heat pump system is a hermetically sealed circuit, and during operation cooling medium K must neither be removed from nor added to it. The power control of the heat pump system is effected on the one hand via a corresponding throttle device in the suction port of the compressor 64 and, on the other hand, via a control of the expansion valve 66 which is dependent upon the cooling medium filling level in the coolant evaporator 54.

In the coolant evaporator 54 of the degasification system 2, the reactor coolant R, which is in the boiling state, is evaporated by way of the described heat input via the heat exchanger 60 of the heat pump circuit 58 at a rate which corresponds to about 5% of the mass flow of gas-containing reactor coolant R flowing in at the column head 8. The stripping vapor D rises in the degasifier column 6 from the bottom upward and, as it passes the bubble caps of the individual trays which are arranged one above the other, comes into intensive contact with the liquid reactor coolant R which trickles down, as a result of which gas is removed from it, as already illustrated above. From the column head 8, the vapor D then passes, mixed with the non-condensable gases which were expelled from the reactor coolant R, into the stripping vapor condenser 34 of the degasifier column 2. Here, the heat of evaporation contained in the vapor D is transferred to the nuclear intermediate cooling water Z, as a result of which most of the vapor D condenses. The condensate is circulated back into the column head 8 via the condensate line 38 by way of gravity, while the smaller, uncondensed portion of the vapor and the flow of the non-condensable gases are routed into the gas cooler 36 which is connected downstream. There, likewise with the release of heat to the nuclear intermediate cooling water Z, another condensation step takes place, in which the remaining proportion of the vapor D condenses with slight undercooling and is then circulated back into the stripping vapor condenser 34 and from there into the column head 8 of the degasifier column 6 in counterflow to the vapor/gas mixture by way of gravity. The non-condensable gas is sucked in with a residual humidity which corresponds to the process temperature by the degasifier vacuum pump 30, compressed and directed into the gaseous waste system (not illustrated) of the power plant.

Degassed coolant R flows into the column sump 10 corresponding to the inflow of gas-containing reactor coolant R at the column head 8. The degassed coolant R is delivered, with the degasifier extraction pump 30, from the column sump 10 which is under low pressure into the collector of the volume control system, to which a pressure of for example 3 to 4 bar is applied by way of the volume equalization tank (not illustrated here). The further delivery into the reactor cooling circuit is effected with the high-pressure delivery pumps of the volume control system.

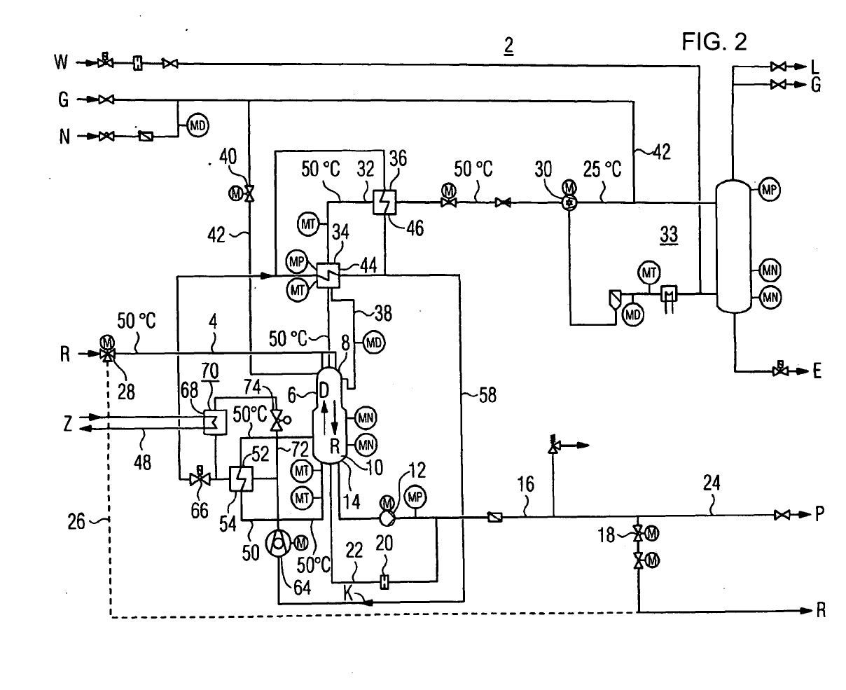

The degasification system 2 illustrated in FIG. 2 differs from that in FIG. 1 in that the heat exchanger 44 of the stripping vapor condenser 34 and the heat exchanger 46 of the gas cooler 36 are connected on the secondary side directly into the heat pump circuit 58 comprising the coolant evaporator 54. The connection line 56 known from FIG. 1 and the heat exchanger 60 are omitted in this variant. Thus, in this variant, the heat from the stripping vapor condenser 34 of the degasification system 2 is dissipated directly by evaporation of the cooling medium K in the connected heat pump circuit 58. As a result, the supply of the degasification system 2 with nuclear intermediate cooling water Z can be designed to be significantly less than in the first variant illustrated in FIG. 1, since the nuclear intermediate cooling water Z is not needed for the transport of heat from the stripping vapor condenser 34 into the heat pump system, but only for the removal of the relatively small amount of thermal power which corresponds to the compression power introduced into the circuit 58 by the compressor heat pump 64. For this purpose, the excess heat exchanger 68, cooled by the intermediate cooling water Z, of the excess condenser 70 is connected on the cooling-medium side into a evaporator bypass line 72 through which flow passes parallel to the coolant evaporator 54 and which is arranged between the compressor heat pump 64 and the expansion valve 66. The mass flow through the evaporator bypass line 72 can be controlled via a control valve 74.

The outflows for the through-connection of the nuclear intermediate cooling water Z, the start-up of the vacuum pump 30, the filling-level control means in the column sump 10 and for the inflow of the gas-containing reactor coolant R correspond to those in the first variant which is illustrated in FIG. 1 and has already been described further above. When the heat pump 64 is switched on, the power must be increased comparatively slowly and care must be taken that heat is not removed too quickly at the stripping vapor condenser 34 of the vacuum degasifier system 2 and undesired, excessive undercooling takes place. As soon as the heat pump system has reached its nominal power output, the steady-state power operation will be maintained solely with the aid of the closed control circuits.

In the exemplary embodiment illustrated in FIG. 2, particularly expedient conditions occur in the participating heat exchangers 44, 52 by way of the fact that on both sides, the respective medium in each case either evaporates or condenses. In the coolant evaporator 54 of the degasification system 2, the cooling medium K condenses on the heat-pump side and the reactor coolant R boils on the vacuum-degasifier side. In the heat exchanger 44 of the stripping vapor condenser 34, the cooling medium K boils on the heat-pump side and the reactor coolant R condenses on the vacuum-degasifier side. These conditions lead in each case across the entire heat-exchanger area to a constant temperature difference, which can therefore be selected to be relatively high without excess losses of energy occurring. This enables the necessary heat-exchanger areas to be kept small.

Furthermore expedient in the variant illustrated in FIG. 2 is the fact that there is only a comparatively small temperature difference between the heat-source side and the heat sink in the heat pump circuit 58. The temperature difference of the cooling medium K between the liquefaction and the evaporation can thus be kept small since it alone must cover the temperature difference necessary for the heat transfer by way of the heat exchanger areas. This means a low pressure ratio for the compressor of the heat pump 64 and leads in the heat pump circuit 58 overall to a high energy efficiency ratio ε which characterizes the ratio between thermal power and supplied drive power. In the vacuum degasifier system 2, the reactor coolant boils at 50° C., i.e. it suffices if the cooling medium vapor flows into the coolant evaporator 54 at a temperature of, for example, 65° C. to 70° C. In the case of such process parameters, the already mentioned cooling medium R134a can be used without difficulty, which has particular advantages for the use in the control area of a nuclear power plant from a safety-technical point of view, such as chemical stability, low toxicity and the fact that it is free of chlorine and is not flammable.

The method according to the two variants illustrated in FIG. 1 and FIG. 2 is efficient particularly if the degasification process takes place under the low pressure conditions already illustrated above at a boiling temperature of about 50° C., since in that case no power for preheating the inflowing reactor coolant R is needed and the thermal power which is used in total for the degasification process is lowest. Accordingly the outlay in terms of apparatus is also lowest under these conditions.

1. A nuclear-engineering plant, comprising:
a pressurized-water reactor and a degasification system for reactor coolant connected to said reactor and including:
a degasifier column through which the reactor coolant can flow;
a coolant evaporator with a first heat exchanger connected to said degasifier column, said first heat exchanger having a primary side and a secondary side;
a stripping vapor condenser with a second heat exchanger;
wherein a partial stream of the reactor coolant flows through said secondary side of said first heat exchanger of said coolant evaporator;
wherein said second heat exchanger of said stripping vapor condenser has a primary side connected into a vapor and gas exit line connected to said degasifier column;
a heat pump circuit connected to said primary side of said first heat exchanger of said coolant evaporator and coupled, in relation to a thermal flow that is established during plant operation, to said second heat exchanger of said stripping vapor condenser, for transferring at least some heat released in a stripping vapor condensation to the reactor coolant flowing through said coolant evaporator and to thereby cause the evaporation thereof.

2. The nuclear-engineering plant according to claim 1, wherein said second heat exchanger has a secondary-side outlet connected through a connection line to a primary-side inlet of a third heat exchanger, and said third heat exchanger has a secondary side connected into said heat pump circuit.

3. The nuclear-engineering plant according to claim 2, wherein said connection line forms a subsection of a nuclear intermediate cooling circuit of an associated nuclear-engineering plant.

4. The nuclear-engineering plant according to claim 1, wherein said second heat exchanger of said stripping vapor condenser has a secondary side connected directly into said heat pump circuit.

5. The nuclear-engineering plant according to claim 4, which further comprises an excess condenser with an excess heat exchanger having a secondary side connected into a nuclear intermediate cooling circuit, and wherein said heat pump circuit includes a controllable bypass line to said first heat exchanger of said coolant evaporator, into which a primary side of said excess heat exchanger is connected.

6. The nuclear-engineering plant according to claim 1, wherein said secondary side of said first heat exchanger of said coolant evaporator is connected into a recirculation line having two ends connected to said degasifier column and conducting a partial flow of the degassed reactor coolant.

7. The nuclear-engineering plant according to claim 1, which further comprises a gas cooler connected, on a coolant side, parallel to said stripping vapor condenser and downstream of said stripping vapor condenser on a vapor and gas side.

8. The nuclear-engineering plant according to claim 1, which further comprises a vacuum pump connected into a gas and vapor exit line, said vacuum pump having a suction power designed for an operating pressure, in an interior of said degasifier column, of less than 0.5 bar.

9. The nuclear-engineering plant according to claim 8, wherein said vacuum pump is configured for an operating pressure in the interior of said degasifier column of less than 0.2 bar.

10. A method of operating a nuclear-engineering plant having a pressurized-water reactor and a degasification system with a coolant evaporator and a stripping vapor condenser for reactor coolant, the method which comprises:
condensing stripping vapor in the stripping water condenser and releasing heat of condensation;
introducing the heat of condensation from the stripping vapor condenser into a heat pump circuit; and
transferring at least some of the heat of condensation to a subflow of the reactor coolant flowing through the coolant evaporator to thereby evaporate the same.

11. The method according to claim 10, which comprises first transferring the heat of condensation released in the stripping vapor condenser to a flow medium and subsequently transferring the heat to a cooling medium carried in the heat pump circuit by way of a heat exchanger.

12. The method according to claim 11, wherein the flow medium is the intermediate cooling water carried in a nuclear intermediate cooling circuit.

13. The method according to claim 10, which comprises transferring the heat of condensation released in the stripping vapor condenser directly to a cooling medium carried in the heat pump circuit.

14. The method according to claim 10, which comprises using a fluorinated hydrocarbon as the cooling medium.

15. The method according to claim 14, wherein the fluorinated hydrocarbon is 1,1,1,2-tetrafluoroethane.

16. The method according to claim 10, which comprises adjusting an operating pressure inside the degasifier column such that a boiling temperature of the reactor coolant therein lies within a range of 40° C. to 60° C.

17. The method according to claim 16, which comprises adjusting the operating pressure inside the degasifier column to set the boiling temperature of the reactor coolant to approximately 50° C.

18. The method according to claim 16, which comprises introducing gas from a gaseous-waste system of the nuclear-engineering plant into the degasifier column for pressure regulation via a gas feed line.

19. The method according to claim 10, which comprises increasing a temperature of the cooling medium in the heat pump circuit, prior to entry into the coolant evaporator, with a compression pump to between 60° C. and 80° C.

20. The method according to claim 19, which comprises increasing the temperature of the cooling medium to approximately 70° C.
